(19) United States
(12) Patent Application Publication
(10) Pub. No.: US 2026/0039487 A1
(43) Pub. Date: Feb. 5, 2026

(54) ENABLING EFFICIENT HASH-BASED SIGNATURE VERIFICATION IN PROCESSOR-BASED DEVICES

(71) Applicant: Microsoft Technology Licensing, LLC, Redmond, WA (US)

(72) Inventors: Kunyan LIU, San Diego, CA (US); Eric Edward EILERTSON, Eagan, MN (US)

(21) Appl. No.: 18/789,622

(22) Filed: Jul. 30, 2024

(51) Int. Cl. H04L 9/00; H04L 9/32

(52) U.S. Cl. CPC H04L 9/50; H04L 9/3242; H04L 9/3247

(57) ABSTRACT

Enabling efficient hash-based signature verification in processor-based devices is disclosed herein. In one exemplary embodiment, a processor-based device includes a processor device and a hash compute core circuit. The hash compute core circuit receives, from a process executing on the processor device, a digit of a plurality of digits of a message digest, a signature value corresponding to the digit, and an initialized context value. The hash compute core circuit generates a hash chain by being configured to, for Y times wherein Y is an integer value calculated using a value of the digit, update the context value, and perform a hash operation on the signature value. The hash compute core circuit then transmits an ending value of the hash chain to the process, which stores the ending value of the hash chain.

### FIELD OF THE DISCLOSURE

The technology of the disclosure relates to hash-based signatures in processor-based devices, and, more particularly, to more efficiently verifying hash-based signatures.

### BACKGROUND

Recent advances in quantum computing have raised the possibility of breaking conventional asymmetric cryptographic algorithms, such as Rivest-Shamir-Adleman (RSA) and elliptic-curve cryptography (ECC) signature schemes, thereby rendering such algorithms insecure. As a result, post-quantum cryptography (PQC) schemes that cannot be broken by quantum computing are becoming increasingly important. One PQC approach being widely adopted is hash-based cryptography, the most popular of which are Leighton-Micali Hash-Based Signatures (LMS) and eXtended Merkle Signature Scheme (XMSS). Both LMS and XMSS have been incorporated into version 2 of the Commercial National Security Algorithm Suite (CNSA) suite as firmware image signing algorithms, and into the National Institute of Standards and Technology (NIST) Special Publication (SP) 800-208 standard.

The process for digitally signing a message using hash-based cryptography involves three (3) steps: key generation, signature generation, and signature verification. To generate a key, a sender first generates a random set of private keys. The sender then performs an operation known as a Winterniz one-time signature (OTS) operation, which involves hashing each private key as a hash chain for a pre-defined number of times. The number of times each private key is hashed is determined by a size of each “digit” or subsection of the message to be signed (e.g., if each digit is eight (8) bits in size, each private key is hashed 256 times). The results of each hash chain are then further hashed together in a structure commonly known as a Merkle tree, with the final hash value at the root of the Merkle tree being the public key.

The sender can then generate a signature for the message by first generating a message digest using, e.g., the Secure Hash Algorithm (SHA) 256, and subdividing the message digest into digits. The sender then hashes each private key corresponding to each digit as a hash chain, with the value of the digit determining the number of times the private key is hashed. The resulting signature comprises the collection of all hash chain outputs, along with intermediate nodes required to trace the Merkle tree. Finally, the sender provides the message, the signature, and the sender's public key to a recipient.

To verify the signature, the recipient generates the message digest and subdivides it into digits. The recipient next hashes each digit of the signature as a hash chain, based on the value of the corresponding digit of the message digest. In the example above where each digit is eight (8) bits in size, each digit of the signature is hashed a number of times equal to 256 minus the value of the corresponding digit of the message digest. The results of each hash chain are then further hashed together as a Merkle tree, and the final hash value at the root of the Merkle tree is compared to the sender's public key. If the final hash value and the public key match, the recipient can conclude that the signature is valid.

One common use for hash-based cryptography is signing firmware images to provide a means to verify validity. Signature verification for this purpose is conventionally done at the time the firmware is loaded by a processor-based device at startup. As a result, the time required to perform signature verification (in particular, the time required to perform the significant number of hash computations required for signature verification) can negatively affect system startup performance. It is therefore desirable to provide a solution that improves processor performance when performing signature verification, while maintaining flexibility with respect to different algorithm variants and without incurring excessive complexity.

### SUMMARY

Exemplary embodiments disclosed herein enable efficient hash-based signature verification in processor-based devices. In this regard, in one exemplary embodiment, a processor-based device provides a hash compute core circuit that is configured to generate hash chains used in signature verification. In exemplary operation, the hash compute core circuit is configured to receive (e.g., from a process executing on a processor device) a digit of a plurality of digits of a message digest, as well as a signature value corresponding to the digit and an initialized context value corresponding to the digit. The hash compute core circuit generates a hash chain by performing a series of operations for Y times, wherein Y is an integer value calculated using a value of the digit. For example, in embodiments in which the digit has a size of eight (8) bits, Y may be calculated as 256 minus the value of the digit. During each iteration, the hash compute core circuit first updates the context value, then performs a hash operation on the signature value (e.g., by invoking a hash primitive of the processor-based device). After generating the hash chain, the hash compute core circuit transmits an ending value of the hash chain to the process, which stores the ending value of the hash chain.

Some embodiments may provide that the process first determines whether the message digest is valid (e.g., based on a checksum, as a non-limiting example). If the process determines that the message digest is not valid, the process raises an exception. However, if the process determines that the message digest is valid, the process transmits each digit of the message digest, the signature value corresponding to each digit, and the initialized context value corresponding to each digit to the hash compute core circuit. In some embodiments, the operations described above for generating hash chains are repeated until no digits of the plurality of digits remain to process. The process in such embodiments then performs a series of operations subsequent to storing a last ending value of a plurality of ending values. The process first generates a plurality of one-time signature (OTS) public keys based on the plurality of ending values, and next computes a Merkle tree based on the OTS public keys. The process then computes a root hash value based on the Merkle tree. Finally, the process validates a public key using the root hash value.

According to some embodiments, the hash compute core circuit may comprise a ping-pong buffer that enables the hash compute core circuit to receive digits in parallel with generating hash chains. In such embodiments, the process transmits a next digit of the plurality of digits of the message digest, a next signature value corresponding to the next digit, and a next initial context value to the hash compute core circuit using the ping-pong buffer in parallel with the hash compute core circuit generating the hash chain.

In another exemplary embodiment, a processor-based device comprises a processor device and a hash compute core circuit. The hash compute core circuit is configured to receive, from a process executing on the processor device, a digit of a plurality of digits of a message digest, a signature value corresponding to the digit, and an initialized context value. The hash compute core circuit is further configured to generate a hash chain by being configured to, for Y times wherein Y is an integer value calculated using a value of the digit, update the context value, and perform a hash operation on the signature value. The hash compute core circuit is also configured to transmit an ending value of the hash chain to the process. The processor device is configured to store, using the process, the ending value of the hash chain.

In another exemplary embodiment, a method for enabling efficient hash-based signature verification is provided. The method comprises receiving, by a hash compute core circuit of a processor-based device from a process executing on a processor device of the processor-based device, a digit of a plurality of digits of a message digest, a signature value corresponding to the digit, and an initialized context value. The method further comprises generating, by the hash compute core circuit, a hash chain by, for Y times wherein Y is an integer value calculated using a value of the digit, updating the context value, and performing a hash operation on the signature value. The method also comprises transmitting, by the hash compute core circuit, an ending value of the hash chain to the process. The method additionally comprises storing, by the process, the ending value of the hash chain.

In another exemplary embodiment, a non-transitory computer-readable medium is provided, the computer-readable medium having stored thereon computer-executable instructions which, when executed by a processor device of a processor-based device, cause the processor device to determine whether a message digest is valid. The computer-executable instructions further cause the processor device to, responsive to determining that the message digest is valid, transmit a digit of a plurality of digits of the message digest, a signature value corresponding to the digit, and an initialized context value to a hash compute core circuit. The computer-executable instructions also cause the processor device to receive, from the hash compute core circuit, an ending value of a hash chain. The computer-executable instructions additionally cause the processor device to store the ending value of the hash chain. The hash compute core circuit is configured to receive, from the processor device, the digit of the plurality of digits of the message digest, the signature value corresponding to the digit, and the initialized context value. The hash compute core circuit is further configured to generate the hash chain by being configured to, for Y times wherein Y is an integer value calculated using a value of the digit, update the context value, and perform a hash operation on the signature value. The hash compute core circuit is also configured to transmit the ending value of the hash chain to a process.

Those skilled in the art will appreciate the scope of the present disclosure and realize additional embodiments thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several embodiments of the disclosure, and together with the description serve to explain the principles of the disclosure:

FIG. 1 is a block diagram of an exemplary processor-based device that includes a processor device and a hash compute core circuit configured to enable efficient hash-based signature verification;

FIG. 2 is a block diagram illustrating exemplary hash-based signature verification by the processor device and the hash compute core circuit of FIG. 1, according to some embodiments;

FIGS. 3A-3C provide a flowchart illustrating exemplary operations of the processor device and the hash compute core circuit of FIG. 1 for enabling efficient hash-based signature verification, according to some embodiments; and

FIG. 4 is a block diagram of an exemplary processor-based device, such as the processor-based device of FIG. 1, that is configured to enable efficient hash-based signature verification.

### DETAILED DESCRIPTION

Exemplary embodiments disclosed herein enable efficient hash-based signature verification in processor-based devices. In this regard, in one exemplary embodiment, a processor-based device provides a hash compute core circuit that is configured to generate hash chains used in signature verification. In exemplary operation, the hash compute core circuit is configured to receive (e.g., from a process executing on a processor device) a digit of a plurality of digits of a message digest, as well as a signature value corresponding to the digit and an initialized context value corresponding to the digit. The hash compute core circuit generates a hash chain by performing a series of operations for Y times, wherein Y is an integer value calculated using a value of the digit. For example, in embodiments in which the digit has a size of eight (8) bits, Y may be calculated as 256 minus the value of the digit. During each iteration, the hash compute core circuit first updates the context value, then performs a hash operation on the signature value (e.g., by invoking a hash primitive of the processor-based device). After generating the hash chain, the hash compute core circuit transmits an ending value of the hash chain to the process, which stores the ending value of the hash chain.

Some embodiments may provide that the process first determines whether the message digest is valid (e.g., based on a checksum, as a non-limiting example). If the process determines that the message digest is not valid, the process raises an exception. However, if the process determines that the message digest is valid, the process transmits each digit of the message digest, the signature value corresponding to each digit, and the initialized context value corresponding to each digit to the hash compute core circuit. In some embodiments, the operations described above for generating hash chains are repeated until no digits of the plurality of digits remain to process. The process in such embodiments then performs a series of operations subsequent to storing a last ending value of a plurality of ending values. The process first generates a plurality of one-time signature (OTS) public keys based on the plurality of ending values, and next computes a Merkle tree based on the OTS public keys. The process then computes a root hash value based on the Merkle tree. Finally, the process validates a public key using the root hash value.

According to some embodiments, the hash compute core circuit may comprise a ping-pong buffer that enables the hash compute core circuit to receive digits in parallel with generating hash chains. In such embodiments, the process transmits a next digit of the plurality of digits of the message digest, a next signature value corresponding to the next digit, and a next initial context value to the hash compute core circuit using the ping-pong buffer in parallel with the hash compute core circuit generating the hash chain.

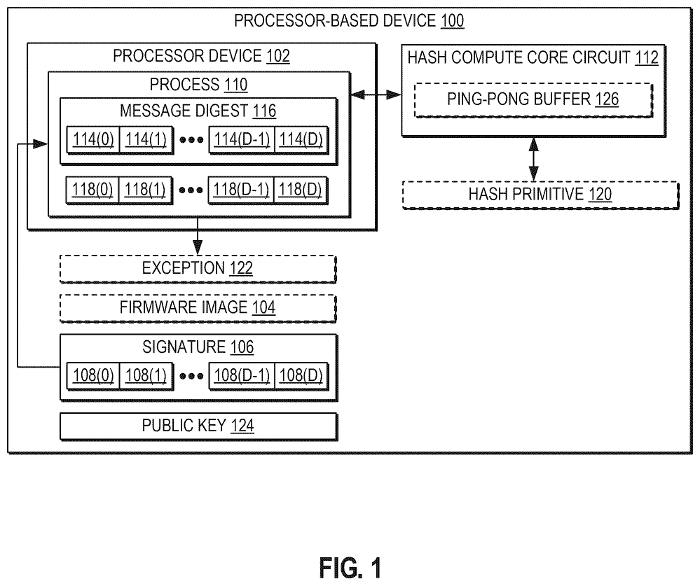

In this regard, FIG. 1 illustrates an exemplary processor-based device 100 that includes a processor device 102. The processor device 102 may comprise one or more processor cores (not shown), each of which may include an instruction processing circuit (not shown) comprising an execution pipeline (not shown) for executing computer instructions. It is to be understood that some embodiments of the processor-based device 100 may comprise multiple processor devices 102 rather than the single processor device 102 shown in the example of FIG. 1, and further that the processor-based device 100 may be one of multiple processor-based devices 100, e.g., organized as a cluster. In some embodiments, the processor-based device 100 may comprise a System-on-Chip (SoC), as a non-limiting example.

The processor-based device 100 of FIG. 1 and the constituent elements thereof may encompass any one of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor sockets or packages. It is to be understood that some embodiments of the processor-based device 100 may include elements in addition to those illustrated in FIG. 1. For example, the processor device 102 may further include one or more instruction caches, unified caches, controller circuits, interconnect buses, and/or additional memory devices, caches, and/or controller circuits.

In the example of FIG. 1, the processor-based device 100 comprises a firmware image 104 that comprises computer-executable instructions for providing low-level control of the hardware elements of the processor-based device 100. The firmware image 104 is signed using a signature 106 that comprises a plurality of signature values 108(0)-108(D). Upon startup of the processor-based device 100, the processor device 102 executes a process 110 to verify the signature 106 and thereby confirm the validity of the firmware image 104. It is to be understood that the signature verification operations discussed herein are described in the context of validating the firmware image 104, but may be applied to any scenario in which verification of a hash-based signature is performed.

As noted above, hash-based signature verification (in particular, the calculation of hash chains) is computationally expensive, and, when performed at system startup, can negatively affect system performance. Conventional approaches to hash-based signature verification have attempted to improve performance by performing hash calculations using specialized hardware circuits. These approaches generally involve data being copied to an input buffer by an executing process, which then initiates hardware hash computation. Upon completion, the results are then copied into memory.

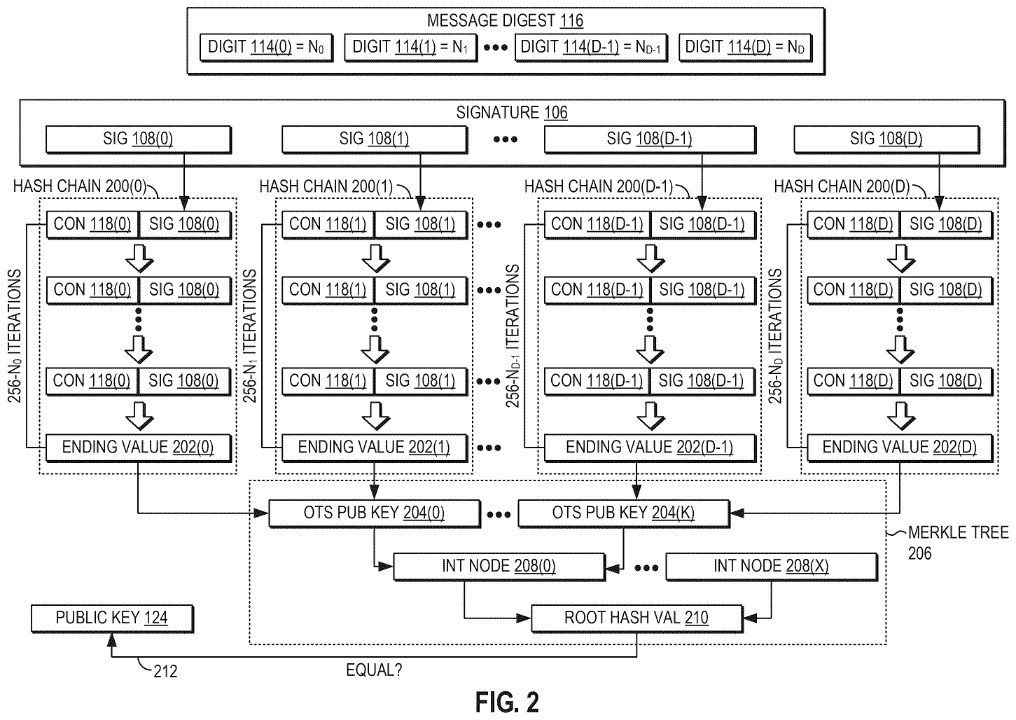

Embodiments disclosed herein are based on the recognition that the copying of data to and from hardware represents a significant portion of the computation time of conventional hardware-assisted hash-based signature verification. Accordingly, the processor-based device 100 of FIG. 1 provides a hash compute core circuit 112 that is configured to perform computations of entire hash chains, thereby minimizing data transfer and the associated overhead. As discussed in greater detail below with respect to FIG. 2, the hash compute core circuit 112 receives digits 114(0)-114(D) of a message digest 116 generated by the process 110 based on the firmware image 104, along with the corresponding signature values 108(0)-108(D) and corresponding context values 118(0)-118(D) initialized by the process 110. Each of the context values 118(0)-118(D) may comprise, e.g., a per-round prefix specified by a Leighton-Micali Hash-Based Signature (LMS), or a bitmask required by an Extended Merkle Signature Scheme (XMSS). For each of the digits 114(0)-114(D) and the corresponding signature values 108(0)-108(D) and corresponding context values 118(0)-118(D), the hash compute core circuit 112 generates a hash chain (not shown), and returns an ending value (not shown) of the hash chain to the process 110, which stores the ending value for later processing. The hash compute core circuit 112 in some embodiments may generate each hash chain using a hash primitive 120 provided by the processor-based device 100.

In the example of FIG. 1, the process 110 first determines whether the message digest 116 is valid (e.g., based on a checksum (not shown), as a non-limiting example). If the process 110 determines that the message digest 116 is not valid, the process 110 in some embodiments may raise an exception 122 and halt the startup process. If the message digest 116 is determined to be valid, the process 110 transmits each of the digits 114(0)-114(D) and the corresponding signature values 108(0)-108(D) and corresponding context values 118(0)-118(D) to the hash compute core circuit 112. After all the digits 114(0)-114(D) have been transmitted and corresponding ending values have been received from the hash compute core circuit 112, the process 110 in some embodiments generates a plurality of OTS public keys (not shown) based on the stored ending values, and then computes a Merkle tree (not shown) based on the OTS public keys. The process 110 next computes a root hash value (not shown) based on the Merkle tree. Finally, the process 110 validates a public key 124 using the root hash value. For example, the process 110 may compare the public key 124 with the root hash value, and if they match, can conclude that the signature 106 is valid.

Some embodiments may further optimize the performance of the hash compute core circuit 112 by providing a ping-pong buffer 126. During a first time interval, the ping-pong buffer 126 receives and stores data from the process 110 in a first portion (not shown) of the ping-pong buffer 126 while the hash compute core circuit 112 processes data in a second portion (not shown) of the ping-pong buffer 126. Subsequently, during a second time interval, the ping-pong buffer 126 receives and stores data from the process 110 in the second portion while the hash compute core circuit 112 processes the data in the first portion. In this manner, the hash compute core circuit 112 can receive the digits 114(0)-114(D) from the process 110 in parallel with generating hash chains.

FIG. 2 illustrates exemplary hash-based signature verification by the processor device 102 and the hash compute core circuit 112 of FIG. 1, according to some embodiments. Elements of FIG. 1 are referenced in describing FIG. 2 for the sake of clarity. As seen in FIG. 2, the message digest 116 comprising the digits 114(0)-114(D) has been generated by the process 110 (not shown in FIG. 2) based on the firmware image 104. The digits 114(0)-114(D) in this example are assumed to have a size of eight (8) bits each, and have corresponding values N₀-N_{D}. The signature 106 comprising the signature values (captioned as “SIG” in FIG. 2) 108(0)-108(D) are also shown in FIG. 2.

In exemplary operation, the hash compute core circuit 112 first receives the digit 114(0) of the message digest 116, the signature value 108(0) corresponding to the digit 114(0), and the initialized context value (captioned as “CON” in FIG. 2) 118(0) from the process 110. The hash compute core circuit 112 next generates a hash chain 200(0) by performing a series of operations for Y times, wherein Y is an integer value calculated using a value of the digit 114(0). In the example of FIG. 2, because the digit 114(0) has a size of eight (8) bits, Y is calculated as 256 minus the value of the digit 114(0) (i.e., 256-N₀), so the hash chain 200(0) is calculated over 256-N₀ iterations. During each iteration, the hash compute core circuit 112 first updates the context value 118(0) as appropriate for the type of the context value 118(0) (e.g., an LMS prefix or an XMSS bitmask, as non-limiting examples), then performs a hash operation on the signature value 108(0) (e.g., by invoking the hash primitive 120 of FIG. 1). After generating the hash chain 200(0), the hash compute core circuit 112 transmits an ending value 202(0) of the hash chain 200(0) to the process 110, which then stores the ending value 202(0) of the hash chain 200(0).

The hash compute core circuit 112 repeats this process for each of the remaining digits 114(0)-114(D). For the digit 114(1), the hash compute core circuit 112 receives the digit 114(1) of the message digest 116, the signature value 108(1) corresponding to the digit 114(1), and the initialized context value 118(1) from the process 110. The hash compute core circuit 112 generates a hash chain 200(1) by performing a series of operations for Y times, wherein Y is an integer value calculated as 256 minus N₁, the value of the digit 114(1). The hash compute core circuit 112 then transmits an ending value 202(1) to the process 110, which stores the ending value 202(1). The hash compute core circuit 112 similarly generates the hash chain 200(D−1) using the digit 114(D−1) of the message digest 116, the signature value 108(D−1) corresponding to the digit 114(D−1), and the initialized context value 118(D−1) received from the process 110 over 256 minus N_{D-1} iterations, and transmits the ending value 202(D−1) to the process 110. Finally, the hash compute core circuit 112 generates the hash chain 200(D) using the digit 114(D) of the message digest 116, the signature value 108(D) corresponding to the digit 114(D), and the initialized context value 118(D) received from the process 110 over 256 minus N_{D} iterations, and transmits the ending value 202(D) to the process 110.

Ater the process 110 stores the last ending value 202(D) of the plurality of ending values 202(0)-202(D), the process 110 generates OTS public keys (captioned as “OTS PUB KEY” in FIG. 2) 204(0)-204(K) based on the ending values 202(0)-202(D). The process 110 next computes a Merkle tree 206 based on the OTS public keys 204(0)-204(K), where the Merkle tree 206 comprises intermediate notes such as the intermediate nodes (captioned as “INT NODE” in FIG. 2) 208(0)-208(X). Using the Merkle tree 206, the process 110 computes a root hash value 210. The process 110 then validates the public key 124 of FIG. 1 using the root hash value 210, e.g., by comparing the public key 124 and the root hash value 210 to determine whether they are equal, as indicated by arrow 212.

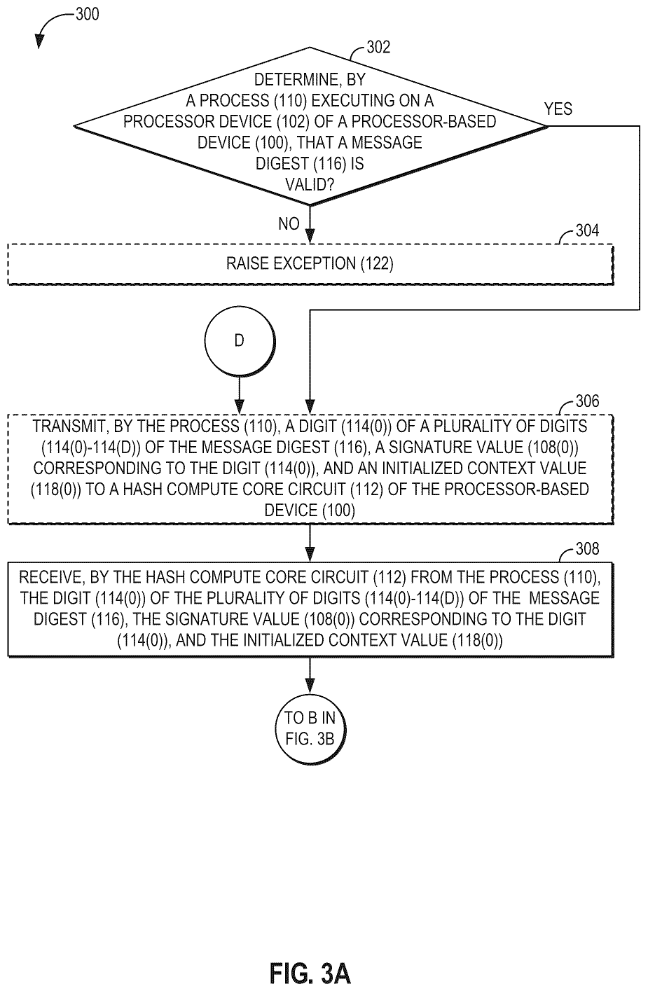

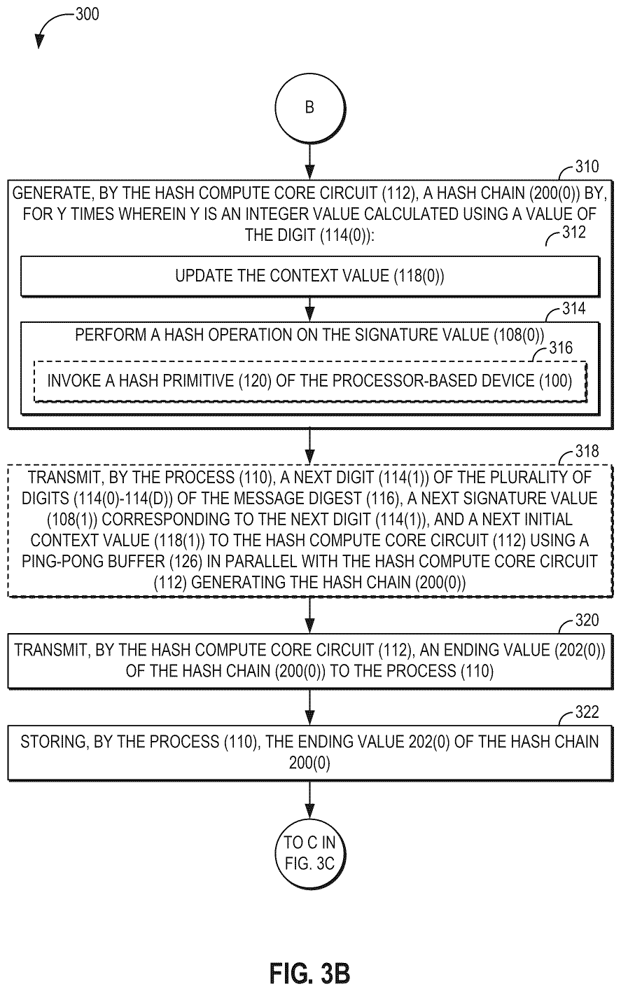

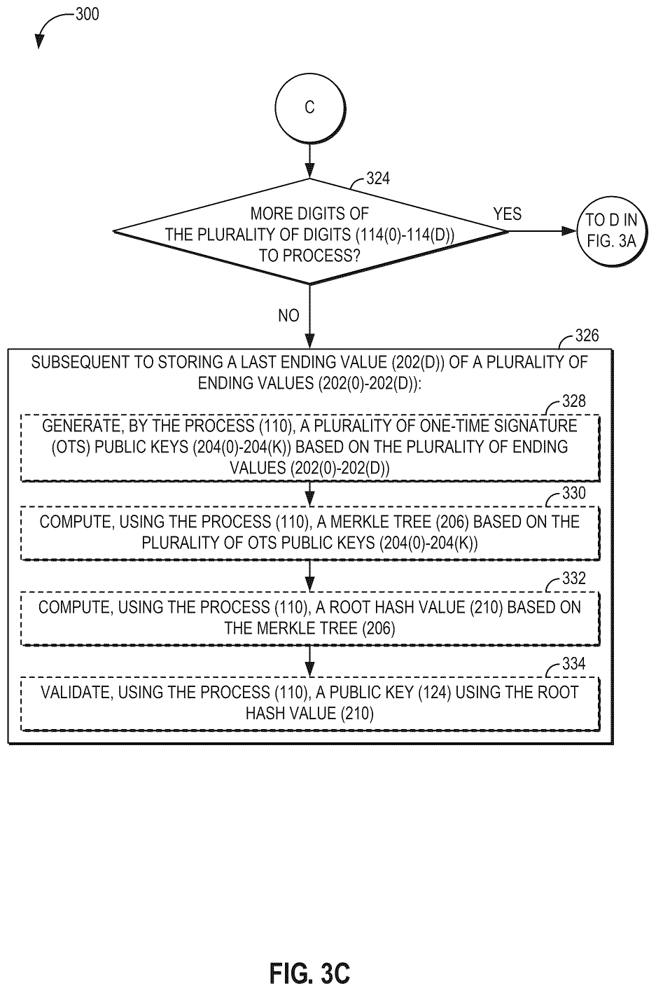

FIGS. 3A-3C provide a flowchart illustrating exemplary operations 300 of the hash compute core circuit 112 of FIG. 1 for enabling efficient hash-based signature verification, according to some embodiments. For the sake of clarity, elements of FIGS. 1 and 2 are referenced in describing FIGS. 3A-3C. It is to be understood that some operations illustrated in FIGS. 3A-3C may occur in an order other than that illustrated in FIGS. 3A-3C in some embodiments, and/or may be omitted in some embodiments.

In FIG. 3A, the exemplary operations 300 in some embodiments begin with a process (e.g., the process 110 of FIG. 1) executing on a processor device (such as the processor device 102 of FIG. 1) of a processor-based device (e.g., the processor-based device 100 of FIG. 1) determining whether a message digest (such as the message digest 116 of FIG. 1) is valid (block 302). If the process 110 determines at decision block 302 that the message digest 116 is not valid, the process 110 raises an exception (e.g., the exception 122 of FIG. 1) (block 304). However, if the process 110 determines at decision block 302 that the message digest 116 is valid, the process 110 transmits a digit (such as the digit 114(0) of FIG. 1) of a plurality of digits (such as the digits 114(0)-114(D) of FIG. 1) of the message digest 116, a signature value (e.g., the signature value 108(0) of FIG. 1) corresponding to the digit 114(0), and an initialized context value (such as the context value 118(0) of FIG. 1) to a hash compute core circuit (e.g., the hash compute core circuit 112 of FIG. 1) of the processor-based device 100 (block 306). The hash compute core circuit 112 then receives the digit 114(0) of the plurality of digits 114(0)-114(D) of the message digest 116, the signature value 108(0) corresponding to the digit 114(0), and the initialized context value 118(0) from the process 110 (block 308). The exemplary operations 300 continue at block 310 of FIG. 3B.

Referring now to FIG. 3B, the hash compute core circuit 112 next generates a hash chain (such as the hash chain 200(0) of FIG. 2) by performing a series of operations for Y times, wherein Y is an integer value calculated using a value of the digit 114(0) (block 310). The hash compute core circuit 112 first updates the context value 118(0) (block 312). The hash compute core circuit 112 then performs a hash operation on the signature value 108(0) (block 314). In some embodiments, the operations of block 314 for performing the hash operation on the signature value 108(0) may comprise the hash compute core circuit 112 invoking a hash primitive (e.g., the hash primitive 120 of FIG. 1) of the processor-based device 100 (block 316). Some embodiments may provide that the process 110 transmits a next digit (such as the digit 114(1) of FIG. 1) of the plurality of digits 114(0)-114(D) of the message digest 116, a next signature value (e.g., the signature value 108(1) of FIG. 1) corresponding to the next digit 114(1), and a next initial context value (such as the context value 118(1) of FIG. 1) to the hash compute core circuit 112 using a ping-pong buffer (e.g., the ping-pong buffer 126 of FIG. 1) in parallel with the hash compute core circuit 112 generating the hash chain 200(0) (block 318).

After generating the hash chain 200(0), the hash compute core circuit 112 transmits an ending value (such as the ending value 202(0) of FIG. 2) of the hash chain 200(0) to the process 110 (block 320). The process 110 then stores the ending value 202(0) of the hash chain 200(0) (block 322). The exemplary operations 300 continue in some embodiments at block 324 of FIG. 3C.

Turning now to FIG. 3C, the process 110 according to some embodiments determines whether there exist more digits of the plurality of digits 114(0)-114(D) to process (block 324). If so, the exemplary operations 300 continue at block 306 of FIG. 3A on a next digit of the plurality of digits 114(0)-114(D). If the process 110 determines at decision block 324 that there exist no more digits of the plurality of digits 114(0)-114(D) to process, the process 110 performs a series of operations subsequent to storing a last ending value (such as the ending value 202(D) of FIG. 2) of a plurality of ending values (e.g., the ending values 202(0)-202(D) of FIG. 2) (block 326). The process 110 first generates a plurality of OTS public keys (such as the OTS public keys 204(0)-204(K) of FIG. 2) based on the plurality of ending values 202(0)-202(D) (block 328). The process 110 next computes a Merkle tree (e.g., the Merkle tree 206 of FIG. 2) based on the plurality of OTS public keys 204(0)-204(K) (block 330). The process 110 next computes a root hash value (such as the root hash value 210 of FIG. 2) based on the Merkle tree 206 (block 332). Finally, the process 110 validates a public key (e.g., the public key 124 of FIG. 1) using the root hash value 210 (block 334).

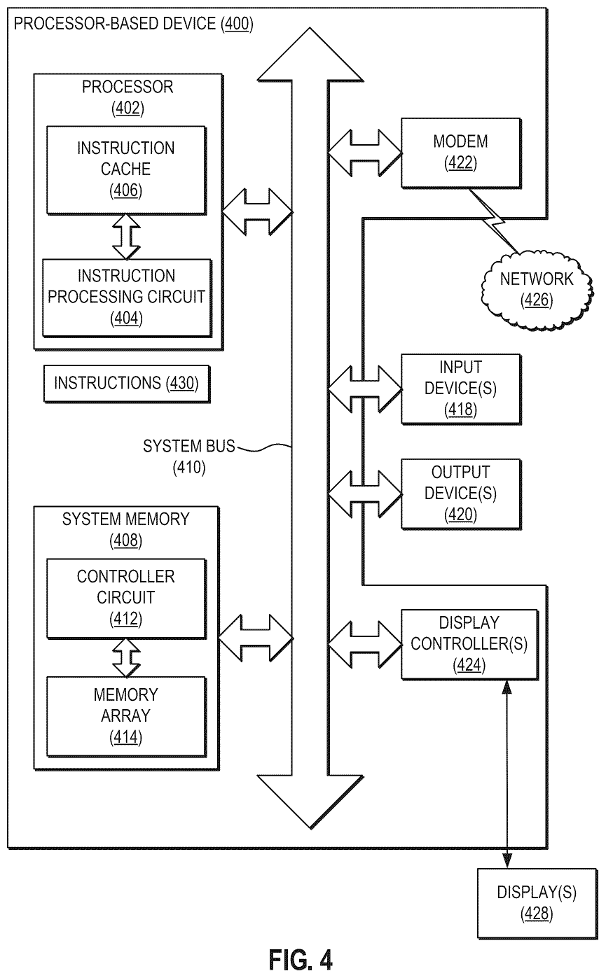

FIG. 4 is a block diagram of an exemplary processor-based device 400 that includes a processor 402 (e.g., a microprocessor) that includes an instruction processing circuit 404. The processor-based device 400 can be the processor-based device 100 in FIG. 1 as an example. The processor-based device 400 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server, or a user's computer.

In this example, the processor 402 represents one or more general-purpose processing circuits, such as a microprocessor, central processing unit, or the like. The processor 402 is configured to execute processing logic in instructions for performing the operations and steps discussed herein. In this example, the processor 402 includes an instruction cache 406 for temporary, fast access memory storage of instructions accessible by the instruction processing circuit 404. Fetched or prefetched instructions from a memory, such as from the system memory 408 over a system bus 410, are stored in the instruction cache 406. The instruction processing circuit 404 is configured to process instructions fetched into the instruction cache 406 and process the instructions for execution.

The processor 402 and the system memory 408 are coupled to the system bus 410 and can intercouple peripheral devices included in the processor-based device 400. As is well known, the processor 402 communicates with these other devices by exchanging address, control, and data information over the system bus 410. For example, the processor 402 can communicate bus transaction requests to a controller circuit 412 in the system memory 408 as an example of a subordinate device. Although not illustrated in FIG. 4, multiple system buses 410 could be provided, wherein each system bus constitutes a different fabric. In this example, the controller circuit 412 is configured to provide memory access requests to a memory array 414 in the system memory 408, and corresponds in functionality to the hash compute core circuit 112 of FIG. 1. The memory array 414 is comprised of an array of storage bit cells for storing data. The system memory 408 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 410. As illustrated in FIG. 4, these devices can include the system memory 408, one or more input device(s) 418, one or more output device(s) 420, a modem 422, and one or more display controllers 424, as examples. The input device(s) 418 can include any type of input device, including but not limited to input keys, switches, voice processors, etc. The output device(s) 420 can include any type of output device, including but not limited to audio, video, other visual indicators, etc. The modem 422 can be any device configured to allow exchange of data to and from a network 426. The network 426 can be any type of network, including but not limited to a wired or wireless network, a private or public network, a local area network (LAN), a wireless local area network (WLAN), a wide area network (WAN), a BLUETOOTH™ network, and the Internet. The modem 422 can be configured to support any type of communications protocol desired. The processor 402 may also be configured to access the display controller(s) 424 over the system bus 410 to control information sent to one or more displays 428. The display(s) 428 can include any type of display, including but not limited to a cathode ray tube (CRT), a liquid crystal display (LCD), a plasma display, etc.

The processor-based device 400 in FIG. 4 may include a set of instructions 430 to be executed by the processor 402 for any application desired according to the instructions. The instructions 430 may be stored in the system memory 408, processor 402, and/or instruction cache 406 as examples of a non-transitory computer-readable medium. The instructions 430 may also reside, completely or at least partially, within the system memory 408 and/or within the processor 402 during their execution. The instructions 430 may further be transmitted or received over the network 426 via the modem 422.

While the computer-readable medium is described herein in an exemplary embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software process.

The embodiments disclosed herein may be provided as a computer program product, or software process, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the processor-based devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A processor-based device, comprising:
a processor device; and
a hash compute core circuit configured to:
receive, from a process executing on the processor device:
a digit of a plurality of digits of a message digest;
a signature value corresponding to the digit; and
an initialized context value;
generate a hash chain by being configured to, for Y times wherein Y is an integer value calculated using a value of the digit:
update the context value; and
perform a hash operation on the signature value; and
transmit an ending value of the hash chain to the process; and
the processor device configured to store, using the process, the ending value of the hash chain.

2. The processor-based device of claim 1, wherein the processor device is further configured to:
determine, using the process, whether the message digest is valid; and
responsive to determining that the message digest is valid, transmit, using the process, the digit of the plurality of digits of the message digest, the signature value corresponding to the digit, and the initialized context value to the hash compute core circuit.

3. The processor-based device of claim 1, wherein:
the processor-based device further comprises a ping-pong buffer; and
the processor device is further configured to transmit, using the process, a next digit of the plurality of digits of the message digest, a next signature value corresponding to the next digit, and a next initial context value to the hash compute core circuit using the ping-pong buffer in parallel with the hash compute core circuit generating the hash chain.

4. The processor-based device of claim 1, wherein the processor device is further configured to, subsequent to storing a last ending value of a plurality of ending values:
generate, using the process, a plurality of One-Time Signature (OTS) public keys based on the plurality of ending values;
compute, using the process, a Merkle tree based on the plurality of OTS public keys;
compute, using the process, a root hash value based on the Merkle tree; and
validate, using the process, a public key using the root hash value.

5. The processor-based device of claim 1, wherein the context value comprises a per-round prefix specified by a Leighton-Micali Hash-Based Signature (LMS).

6. The processor-based device of claim 1, wherein the context value comprises a bitmask required by an Extended Merkle Signature Scheme (XMSS).

7. The processor-based device of claim 1, wherein the hash compute core circuit is configured to perform the hash operation by being configured to invoke a hash primitive of the processor-based device.

8. The processor-based device of claim 1, wherein the signature value is one of a plurality of signature values of a signature used to sign a firmware image.

9. A method for enabling efficient hash-based signature verification, comprising:
receiving, by a hash compute core circuit of a processor-based device from a process executing on a processor device of the processor-based device:
a digit of a plurality of digits of a message digest;
a signature value corresponding to the digit; and
an initialized context value;
generating, by the hash compute core circuit, a hash chain by, for Y times wherein Y is an integer value calculated using a value of the digit:
updating the context value; and
performing a hash operation on the signature value;
transmitting, by the hash compute core circuit, an ending value of the hash chain to the process; and
storing, by the process, the ending value of the hash chain.

10. The method of claim 9, further comprising:
determining, by the process, that the message digest is valid; and
responsive to determining that the message digest is valid, transmitting, by the process, the digit of the plurality of digits of the message digest, the signature value corresponding to the digit, and the initialized context value to the hash compute core circuit.

11. The method of claim 10, further comprising transmitting, by the process, a next digit of the plurality of digits of the message digest, a next signature value corresponding to the next digit, and a next initial context value to the hash compute core circuit using a ping-pong buffer in parallel with the hash compute core circuit generating the hash chain.

12. The method of claim 9, further comprising, subsequent to storing a last ending value of a plurality of ending values:
generating, by the process, a plurality of One-Time Signature (OTS) public keys based on the plurality of ending values;
computing, by the process, a Merkle tree based on the plurality of OTS public keys;
computing, by the process, a root hash value based on the Merkle tree; and
validating, by the process, a public key using the root hash value.

13. The method of claim 9, wherein the context value comprises a per-round prefix specified by a Leighton-Micali Hash-Based Signature (LMS).

14. The method of claim 9, wherein the context value comprises a bitmask required by an Extended Merkle Signature Scheme (XMSS).

15. The method of claim 9, wherein the hash compute core circuit is configured to perform the hash operation by being configured to invoke a hash primitive of the processor-based device.

16. The method of claim 9, wherein the signature value is one of a plurality of signature values of a signature used to sign a firmware image.

17. A non-transitory computer-readable medium, having stored thereon computer-executable instructions that, when executed by a processor device, cause the processor device to:
determine whether a message digest is valid;
responsive to determining that the message digest is valid, transmit a digit of a plurality of digits of the message digest, a signature value corresponding to the digit, and an initialized context value to a hash compute core circuit;
receive, from the hash compute core circuit, an ending value of a hash chain; and
store the ending value of the hash chain;
wherein the hash compute core circuit is configured to:
receive, from the processor device, the digit of the plurality of digits of the message digest, the signature value corresponding to the digit, and the initialized context value;
generate the hash chain by being configured to, for Y times wherein Y is an integer value calculated using a value of the digit:
update the context value; and
perform a hash operation on the signature value; and
transmit the ending value of the hash chain to a process.

18. The non-transitory computer-readable medium of claim 17, wherein the computer-executable instructions further cause the processor device to transmit a next digit of the plurality of digits of the message digest, a next signature value corresponding to the next digit, and a next initial context value to the hash compute core circuit using a ping-pong buffer in parallel with the hash compute core circuit generating the hash chain.

19. The non-transitory computer-readable medium of claim 17, wherein the computer-executable instructions further cause the processor device to, subsequent to storing a last ending value of a plurality of ending values:
generate a plurality of One-Time Signature (OTS) public keys based on the plurality of ending values;
compute a Merkle tree based on the plurality of OTS public keys;
compute a root hash value based on the Merkle tree; and
validate a public key using the root hash value.

20. The non-transitory computer-readable medium of claim 17, wherein the context value comprises one of a per-round prefix specified by a Leighton-Micali Hash-Based Signature (LMS) and a bitmask required by an Extended Merkle Signature Scheme (XMSS).
